(19) United States
(12) Patent Application Publication
(10) Pub. No.: US 2026/0235913 A1
(43) Pub. Date: Aug. 13, 2026

(54) COMPOSITE PANE HAVING ELECTRICALLY CONTROLLABLE OPTICAL PROPERTIES

(71) Applicant: SAINT-GOBAIN SEKURIT FRANCE, THOUROTTE (FR)

(72) Inventors: Sebastian SCHURSE, HERZOGENRATH (DE); Bernhard REUL, HERZOGENRATH (DE)

(21) Appl. No.: 19/156,748

(22) PCT Filed: Jan. 17, 2024
(86) PCT No.: PCT/EP2024/051010

§ 371 Date: Aug. 14, 2025

(30) Foreign Application Priority Data
Feb. 15, 2023 (EP) 23156715.7

(51) Int. Cl. G02F 1/1345; G02F 1/1343

(52) U.S. Cl. CPC G02F 1/1345; G02F 1/134309; G02F 1/13439

(57) ABSTRACT

A composite pane with electrically controllable optical properties having an electrically controllable functional element includes, in the specified order, a first carrier film, a first planar electrode, an active layer or layer sequence with electrically controllable optical properties, a second planar electrode and a second carrier film. The second carrier film, the second planar electrode and the active layer or layer sequence are removed and the first planar electrode is electrically conductively connected to a current collector rail in a first contacting area. The first carrier film, the first planar electrode and the active layer or layer sequence are removed and the second planar electrode is electrically conductively connected to at least one current collector rail in a second contacting area. The first and second contacting areas are arranged on opposite sides of the functional element.

The invention relates to a composite pane with electrically controllable optical properties, and use thereof.

Composite panes with electrically controllable optical properties are known as such. They are equipped with functional elements which comprise an active layer or layer sequence between two planar electrodes, wherein the optical properties of the active layer or layer sequence can be changed by an electrical voltage applied to the planar electrodes. An example of such functional elements are SPD (suspended particle device) functional elements, which are known, for example, from EP 0876608 B1 and WO 2011033313A1. By applying voltage, the transmission of visible light can be controlled by SPD functional elements. Another example are PDLC (polymer-dispersed liquid crystal) functional elements, which are known, for example, from DE 102008026339A1 . The active layer contains liquid crystals which are embedded in a polymer matrix. If no voltage is applied, the liquid crystals will be aligned in an unordered manner, which results in strong scattering of the light passing through the active layer. If a voltage is applied to the planar electrodes, the liquid crystals will align in a common direction and the transmittance of light through the active layer is increased. The PDLC functional element operates primarily by increasing the scattering instead of by reducing the total transmission, as a result of which a clear view can be prevented or anti-glare protection can be ensured. In addition, electrochromic functional elements are known, for example from US 20120026573A1, WO 2010147494 A1 and EP 1862849 A1 and WO 2012007334A1, in which a change in transmission is the result of electrochemical processes induced by the applied electrical voltage.

Such composite panes can be used, for example, as vehicle window panes, whose light transmission behaviour can then be controlled electrically. They can be used, for example, as roof panes to reduce exposure to direct sunlight or disruptive reflections. Such roof panes are known, for example, from DE 10043141 A1 and EP 3456913A1. Windshields in which an electrically controllable sun screen is realised by a switchable functional element in order to replace the conventional mechanically foldable sun screen in motor vehicles have also been proposed. Windshields with electrically controllable sun screens are known, for example, from DE 102013001334A1, DE 102005049081B3, DE 102005007427 A1 and DE 102007027296A1. Such composite panes can be used not only in the automotive sector, but also, for example, in building glazing or interior window panes. The electrically controllable functional elements are typically provided as a multilayer film and embedded in the intermediate layer of the composite pane. The multilayer film is composed of two carrier films, typically based on PET, with the planar electrodes deposited on them, typically based on ITO, and the active layer or layer sequence in between. For electrical contacting, a contacting area is typically created for each planar electrode by removing the opposite carrier film with the other planar electrode and the active layer or layer sequence, so that said planar electrode is exposed in the contacting area and can be electrically contacted via a current collector rail, typically a strip of copper foil. Electrical conductors are connected to the current collector rails and extend beyond the side edge of the composite pane to connect the functional element to the external voltage source.

The contacting areas of the two planar electrodes are typically formed on opposite sides of the functional element, which is advantageous for the optical behaviour of the functional element because, in particular, a more uniform and sometimes faster switching behaviour is ensured. However, this fact brings with it disadvantages in terms of production. Since the process steps for electrical contacting are carried out on opposite sides of the functional element, the production outlay is increased. In particular, comparatively long electrical conductors, which are applied, for example, as metal wires using a plotter to thermoplastic films of the intermediate layer of the composite pane, which is time-consuming, are required.

From DE202018102520U1 a composite pane with an electrically controllable functional element is known, the contacting areas of which are arranged on opposite sides of the functional element. The current collector rails have an L-shape, so that the current collector rail of the first planar electrode runs in a connection area starting from a first contacting area to the opposite side of the functional element. This allows the electrical conductors to be connected to the two current collector rails on the same side of the functional element. Since the second carrier film, the second planar electrode and the active layer or layer sequence must be removed in the connection area in order to arrange the current collector rail on the first planar electrode, and the second planar electrode then directly adjoins the connection area in which the first planar electrode is exposed, there is a risk that the second planar electrode comes into contact with the first planar electrode, the current collector rail of the first planar electrode or their electrical contacts and causes a short circuit.

The present invention addresses the problem of providing an improved composite pane with electrically controllable optical properties, which is in particular easier to produce and in which short circuits are avoided.

The problem is solved in accordance with the invention by a composite pane with electrically controllable optical properties according to independent claim 1. Advantageous embodiments result from the dependent claims.

The invention is based on the approach of extending one of the current collector rails and leading it in a connection area to the opposite side of the functional element, where the other current collector rail is also positioned.

The electrical connection of both current collector rails can then be made on the same side of the functional element, which reduces the production effort. This also means that fewer long electrical conductors are required, so that their design can be implemented more quickly, for example with a plotter. These are great advantages of the present invention.

The composite pane according to the invention with electrically controllable optical properties comprises an outer pane and an inner pane which are connected to one another via a thermoplastic intermediate layer. The composite pane also comprises an electrically controllable functional element embedded in the intermediate layer. The functional element comprises, in the specified order, a first carrier film, a first planar electrode, an active layer or layer sequence with electrically controllable optical properties, a second planar electrode and a second carrier film. The carrier films, the planar electrodes and the active layer/layer sequence are typically arranged substantially parallel to the surfaces of the outer pane and the inner pane.

The functional element has a first contacting area which is provided for the electrical connection of the first planar electrode. In the first contacting area, the second carrier film, the second planar electrode and the active layer or layer sequence are removed. The first carrier film and the first planar electrode remain in the first contacting area so that the first planar electrode is exposed and can be electrically contacted. In the first contacting area, the first planar electrode is electrically conductively connected to a current collector rail. For this purpose, the current collector rail is arranged in the first contacting area on the first planar electrode.

The functional element also has a second contacting area which is provided for the electrical connection of the second planar electrode. The first carrier film, the first planar electrode and the active layer or layer sequence are removed in the second contacting area. The second carrier film and the second planar electrode remain in the second contacting area so that the second planar electrode is exposed and can be electrically contacted. The second planar electrode is electrically conductively connected to at least one current collector rail in the second contacting area. For this purpose, the at least one current collector rail is arranged in the second contacting area on the second planar electrode.

According to the invention, the first contacting area and the second contacting area are arranged on opposite sides of the functional element. The current collector rail of the first planar electrode (i.e. the current collector rail which is arranged in the first contacting area on the first planar electrode, connected to it and electrically conductively connected to it) runs in a connection area starting from the first contact area to the opposite side of the functional element. The connection area is formed exactly like the first contacting area in that the second carrier film, the second planar electrode and the active layer or layer sequence are removed.

The contacting areas preferably have a width of 3 mm to 20 mm, particularly preferably of 5 mm to 10 mm. The connection area preferably has a width of 3 mm to 20 mm, particularly preferably of 5 mm to 10 mm. The width is the dimension perpendicular to the intended direction of extension of the current collector rails.

The functional element according to the invention is divided into
at least one active area in which both carrier films, both planar electrodes and the active layer or layer sequence are present and in which the optical properties can be electrically controlled,
the first and second contacting area and
the connection area.

The current collector rail of the first planar electrode and the at least one current collector rail of the second planar electrode (i.e. the current collector rail or current collector rails which are arranged in the second contacting area on the second planar electrode, connected to it and electrically conductively connected to it) are connected to a voltage source via electrical conductors. The electrical conductors are preferably connected on the same side of the functional element to the current collector rail of the first planar electrode and the at least one current collector rail of the second planar electrode.

The contacting areas are preferably formed directly adjacently to the side edge of the functional element. The first contacting area and the second contacting area directly adjoin opposite portions of the side edge of the functional element.

In one embodiment, the connection area is also formed directly adjacently to the side edge of the functional element. It directly adjoins a portion of the side edge which extends between the portions of the side edge with the first and the second contacting area. The connection area is connected to one end of the first contacting area and runs from there to the opposite side of the functional element.

In a further embodiment, the connection area is not formed directly adjacently to the side edge of the functional element. It runs in a central area of the functional element, wherein it adjoins both sides on active areas of the functional element. The connection area is connected to a portion of the first contacting area located between the ends and runs from there to the opposite side of the functional element. The connection area divides the second planar electrode and the second contacting area into two portions, wherein each portion is assigned to an active area of the functional element.

The functional element is not limited to a specific shape. Typically, the functional element has an at least approximately quadrangular, in particular at least approximately rectangular shape (relative to the plan view in the direction of view through the composite pane). The functional element has four corners and four sides, wherein adjacent sides are each connected to one another by a corner. The term “approximately” means that the shape can deviate from the ideal geometric quadrilateral or rectangle in that the sides do not have to be straight, but can, for example, be curved convexly or concavely or wavy, independently of one another.

The contacting areas are arranged on two opposite sides, in particular directly adjacent to the side edge or said sides. The two other sides run between the sides with the contacting areas, in particular substantially perpendicular to them. The connection area runs preferably substantially parallel to these further sides, wherein it can be adjacent to one of the two or can run in a region between these further sides.

The second contacting area and the connection area may overlap. Then, as it were, a portion of the functional element is cut off, namely the area of overlap in which the carrier films with the planar electrodes located on them are removed, since the active layer or layer sequence alone is not stable. Alternatively, it is also conceivable that the second contacting area and the connection area abut each other directly, viewed in plan view of the functional element or the composite pane. This is the case when the cutting line for removing the first carrier film in the second contacting area and the cutting line for removing the second carrier film in the connection area are arranged in layers in an overlapping portion, viewed in plan view.

In an advantageous embodiment, however, the second contacting area and the connection area do not overlap. The second contacting area and the connection area do not abut each other in the sense mentioned above. Instead, when viewed from above onto the functional element or the composite pane, there is at least one intermediate area between the second contacting area and the connection area. The cutting line for removing the first carrier film in the second contacting area is therefore guided to the side edge of the functional element before it reaches the connection area. In this intermediate area, the first carrier film, the first planar electrode and the active layer or layer sequence are not removed, but extend in particular to the side edge of the functional element on the side on which the electrical connection is made. The second carrier film and the second planar electrode also extend in the intermediate area to the side edge of the functional element on the side on which the electrical connection is made.

In a preferred variant, in the intermediate area, a part of the second planar electrode which, viewed in plan view, adjoins the connection area is electrically insulated from the remaining second planar electrode by at least one insulation line. The at least one insulation line runs preferably from the side of the functional element with the second contacting area to the opposite first contacting area. The at least one insulation line divides the second planar electrode into at least one active area, in which it actually acts as a planar electrode and applies a voltage to the active layer/layer sequence, and at least one area which is electrically insulated therefrom and which, viewed in plan view, adjoins the connection area. The electrical insulation of the part of the second planar electrode adjacent to the connection area reduces in particular the risk of short circuits. This is advantageous because this part of the second planar electrode is directly adjacent to the connection area in which the first planar electrode is exposed and in which the current collector rail runs, so that there is a risk that this part of the second planar electrode will come into contact with the first planar electrode, the current collector rail of the first planar electrode or their electrical contacts and cause a short circuit.

The at least one insulation line for insulating the region of the second planar electrode adjacent to the connection area has, for example, a width (line width) of 5 μm to 500 μm, in particular 20 μm to 200 μm. It is preferably introduced into the second planar electrode by means of laser radiation.

If the connection area adjoins the side edge of the functional element, a single insulation line is sufficient, which divides the second planar electrode into an active area and an electrically insulated area adjoining the connection area. If the connection area does not adjoin the side edge of the functional element, two insulation lines are used, which divide the second planar electrode into two active areas and two electrically insulated areas, each adjoining the connection area on one side.

In one embodiment of the invention, the second planar electrode (or each of its active areas if the second planar electrode is divided into two portions by a connection area not adjacent to the side edge of the functional element and/or a region of the second planar electrode adjacent to the connection area is insulated from at least one active area by at least one insulation line in at least one intermediate area) is formed as a continuous, uninterrupted layer. It is not divided into several electrically insulated segments by insulation lines. The functional element (or its active area) can then be brought into a uniform optical state by the applied electrical voltage; there are no independently controllable switching regions. The second planar electrode is preferably electrically conductively connected to a single current collector rail in the second contacting area. If the second planar electrode is divided into two portions by a connection area not adjacent to the side edge of the functional element, each section is preferably electrically conductively connected to a single current collector rail. The second planar electrode and the first planar electrode are electrically connected to the voltage source so that an electrical voltage can be applied between the second planar electrode on the one hand and the first planar electrode on the other hand in order to control the optical properties of the active layer/layer sequence located therebetween.

In a further embodiment of the invention, the second planar electrode (or at least one, preferably each of its active areas, if the second planar electrode is divided into two portions by a connection area not adjacent to the side edge of the functional element and/or a region of the second planar electrode adjacent to the connection area is insulated from at least one active area by at least one insulation line in at least one intermediate area) is divided into at least two separate electrode segments by at least one insulation line. Each electrode segment is electrically conductively connected to a (individual or separate) current collector rail. Each electrode segment of the second planar electrode and the first planar electrode (or active region thereof) is electrically connected to the voltage source, so that an electrical voltage can be applied independently between each electrode segment of the second planar electrode and the first planar electrode (or active region thereof) in order to control the optical properties of the portion of the active layer/layer sequence located between them. In this way, several independent switching regions can be realised, the optical properties of which can be electrically controlled independently of one another.

In this embodiment, therefore, the second planar electrode has at least two segments (electrode segments) which are separated from one another by an insulation line. The second planar electrode can be subdivided into several segments by several insulation lines. Each electrode segment forms a switching region of the composite pane. The number of electrode segments can be freely selected by the person skilled in the art as needed on an individual basis. In a preferred embodiment, the isolation lines run substantially parallel to one another and extend from a side edge of the planar electrode to the opposite side edge. However, any other geometric shapes are also conceivable.

The isolation lines between the segments of the second planar electrode have, for example, a width of 5 μm to 500 μm, in particular 20 μm to 200 μm. They are preferably introduced into the second planar electrode by means of laser radiation. The width of the segments, i.e. the distance between adjacent insulation lines, can be suitably selected by the person skilled in the art according to the requirements in individual cases.

The electrode segments of the second planar electrode are electrically connected to the voltage source independently of one another, so that a second electrical potential (constant over time in the case of a direct voltage, variable over time in the case of an alternating voltage) can be applied to each electrode segment (independently of the other electrode segments), which can also be referred to as a switching potential. The first planar electrode (or its active area) is also electrically connected to the voltage source, so that a first electrical potential, which can also be referred to as reference potential (“ground”), can be applied to the first planar electrode (or its active area) as a whole. If the first and the second potentials are identical, no voltage will be present between the electrodes in the respective switching region (0% switching state). If the first and second potentials are different, a voltage is applied between the electrodes in the respective switching region, creating a finite switching state (switching state up to 100%, which corresponds to the maximum change in the optical properties of the active layer/layer sequence).

The first planar electrode is formed preferably as a continuous, uninterrupted layer. The first planar electrode therefore has no insulation lines that would divide it into independent segments. A uniform electrical potential is preferably applied to the first planar electrode.

An insulation line is understood to mean a line-like or line-shaped area in which the material of the planar electrode is not present, so that the adjacent portions (segments) are materially separated from one another and are therefore electrically insulated from one another. This means that there is no direct electrical connection between the portions (segments), but the portions (segments) can be connected to one another indirectly to a certain extent in an electrically conductive manner via the active layer in contact with them.

The current collector rails serve to distribute the electrical contact of the respective planar electrode with the voltage source over a comparatively large contact area and to introduce or discharge the electrical current over the largest possible width. They are also called “busbars”. The current collector rails preferably have a thickness of 2 mm to 20 mm, particularly preferably of 4 mm to 9 mm. The width of the current collector rails is preferably smaller than the width of the contacting areas and the connection area, for example by about 1 mm. The current collector rails are preferably formed from an electrically conductive foil (in particular as a strip or portion of the electrically conductive foil). The foil is particularly preferably a metal foil, in particular copper foil. The copper foil can be tin-coated. The metal foil for example has a thickness of 0.02 mm to 0.2 mm, preferably of 0.05 mm to 0.1 mm. However, polymeric carrier films can also be used which are provided with an electrically conductive coating, for example a silver coating.

The current collector rails can be formed independently of one another in one piece (i.e. from a single strip or portion of the electrically conductive foil) or in multiple pieces (i.e. from several combined strips or portions of the electrically conductive foil). In a preferred embodiment, the current collector rail of the second planar electrode is formed in one piece (in particular as a strip of the electrically conductive foil) and the current collector rail of the first planar electrode is formed in one piece or in multiple pieces. In the case of the multi-piece design, the two portions of the current collector rail on the contacting area and the connection area are preferably each formed in one piece and connected to one another, for example placed on top of one another, soldered or glued in an electrically conductive manner. The current collector rail of the first planar electrode typically has an L-like shape (when the connecting portion is adjacent to a side edge of the functional element) or a T-like shape (when the connecting portion is not adjacent to a side edge of the functional element). In the one-piece design, either a T-or L-shaped portion of the electrically conductive foil can be used or a strip of the electrically conductive foil can be folded into the T-or L-like shape.

The current collector rails are electrically conductively connected to the associated planar electrode. The current collector rails can, for example, simply be placed on the planar electrode, soldered to the planar electrode, or connected to the planar electrode via an electrically conductive adhesive. In an advantageous embodiment, an electrical contact layer is arranged between the planar electrode and the current collector rail in order to improve the electrical contact. The contact layer can be formed, for example, as a silver-containing paste with a thickness of 0.01 mm to 0.2 mm, preferably from 0.02 mm to 0.1 mm, in particular from 0.02 mm to 0.05 mm.

An electrical conductor is connected to the current collector rail of the first planar electrode and to the current collector rail of the second planar electrode or to the current collector rails of the various segments of the second planar electrode, which extends beyond the side edge of the composite pane in order to be connected to the external voltage source. The conductor can be made in one piece or in multiple pieces. This conductor can be, for example, a metal wire, a metal foil and/or an electrical cable extending from the respective planar electrode beyond the side edge of the composite pane.

In an advantageous development of the invention, said conductors comprise a ribbon conductor which extends beyond the side edge of the composite pane and to which the current collector rails of the planar electrodes are connected via electrical conductors. The composite pane then has the ribbon conductor. The ribbon conductor is arranged laterally at a certain distance from the functional element, in particular on the side with the second contacting area, where the electrical connection is made, and extends beyond the side edge of the composite pane. The current collector rail of the first planar electrode and the at least one current collector rail of the second planar electrode are connected to the ribbon conductor via electrical conductors. The ribbon conductor advantageously makes the electrical connection of the functional element easier. In particular, the effort of laying a number of separate cables for each individual current collector rail is dispensed with.

The ribbon conductor has a plurality of electrically conductive tracks, in particular each formed from a strip of a metal foil (for example copper foil). Preferably, all electrically conductive tracks are connected by a polymer sheath or carrier layer to form a component. The first planar electrode is assigned a conductive track to which it is connected via electrical conductors. The second planar electrode
is assigned a conductive track to which it is connected via electrical conductors, or
several conductive tracks are assigned, wherein each segment of the second planar electrode is connected to a (separate) track via electrical conductors, so that each electrode segment is connected to exactly one track and each track is connected to exactly one electrode segment. The ribbon conductor can of course also have tracks that are not connected to any electrode or electrode segment and are not used for electrical connection (“blind tracks”).

In a preferred embodiment of the invention, an electrical contact element is connected to each of the current collector rails. In other words, the current collector rails are each provided with an electrical contact element, wherein the contact element is, for example, placed on the current collector rails, soldered to them or glued with a conductive adhesive. The electrical contact element is preferably formed from an electrically conductive foil, in particular copper foil. The copper foil can be tin-coated. The metal foil for example has a thickness of 0.02 mm to 0.2 mm, preferably of 0.05 mm to 0.1 mm. Alternatively, the contact element can be designed, for example, as a carrier film with an electrically conductive coating, for example a silver coating. The contact element preferably has at least one portion which extends from the current collector rail beyond the side edge of the functional element, in particular substantially perpendicular to the running direction of the current collector rail. This portion is preferably connected to the ribbon conductor. The contact element can, for example, have a strip-like or T-like shape.

The contact element can be connected directly to the ribbon conductor. Alternatively, the contact element can be connected indirectly to the ribbon conductor via an electrical line. The electrical lines are preferably metal wires, electrical cables or printed lines.

The contact element can also be used in cases where the electrical lines themselves extend beyond the side edge of the composite pane, i.e. there is no common ribbon conductor.

The electrically controllable functional element is a multilayer film or functional film with the actual active layer or layer sequence and the planar electrodes between two carrier films. Such multilayer films can be purchased commercially, cut to size and shape and then laminated into the composite pane, wherein they are preferably connected via a respective thermoplastic connection layer to the outer pane and the inner pane.

The first and the second carrier films are formed for example on the basis of polyethylene terephthalate (PET), polypropylene, polyvinyl chloride, fluorinated ethylene propylene, polyvinyl fluoride or ethylene tetrafluoroethylene, preferably on the basis of PET. The thickness of the carrier films is preferably from 10 μm to 200 μm.

The side edge of the functional element can be sealed, for example by merging the carrier layers or by a (preferably polymeric) tape or polymeric film.

The active layer can thus be protected, in particular from constituents of the intermediate layer (in particular plasticisers) diffusing into the active layer, which can lead to degradation of the functional element.

The first and the second planar electrodes are preferably transparent, which in the context of the invention means that they have a light transmission in the visible spectral range of at least 50%, preferably at least 70%, particularly preferably at least 80%. The planar electrodes preferably contain at least one metal, a metal alloy or a transparent conducting oxide (TCO). The planar electrodes can, for example, be based on silver, gold, copper, nickel, chromium, tungsten, indium tin oxide (ITO), gallium-doped or aluminium-doped zinc oxide and/or fluorine-doped or antimony-doped tin oxide, preferably based on silver or ITO. The planar electrodes preferably have a thickness of 10 nm to 2 μm, particularly preferably of 20 nm to 1 μm, very particularly preferably of 30 nm to 500 nm.

The active layer or layer sequence has the variable optical properties which can be controlled by a voltage applied to the active layer via the planar electrodes. In the context of the invention, electrically controllable optical properties are understood, in particular, to mean such properties which are continuously controllable. In principle, however, it is also conceivable that the electrically controllable optical properties can only be switched between two discrete states (or also between more than two discrete states). Said optical properties relate in particular to the light transmission and/or the scattering behaviour.

Depending on the type of functional element, there may be a single active layer or an active layer sequence (i.e. a plurality of different layers which together provide the variable optical properties). Various types of functional elements can be used, wherein in preferred embodiments the functional element is a functional element based on liquid crystal technology (in particular a PDLC functional element), an SPD functional element or an electrochromic functional element.

Functional elements based on liquid crystal technology contain an active layer with liquid crystals. The liquid crystals can be aligned by applying a voltage to the planar electrodes, which is the basis for the electrical control of the optical properties. In particular, the following functional elements based on liquid crystal technology are common:
PDLC (polymer-dispersed liquid crystal) functional elements: The active layer contains drops of liquid crystals in a polymer matrix. If the liquid crystals are aligned in an electric field, the state is transparent and not light-scattering; if the liquid crystals are not aligned without an electric field, the state is translucent and strongly light-scattering.
PNLC (polymer-networked liquid crystal) functional elements: The active layer contains liquid crystals embedded in a polymer network. Without an applied voltage, the liquid crystals are aligned and the state is transparent and non-light-scattering. When an electrical voltage is applied, configuration changes occur, which lead to strong scattering at the liquid crystals, so that the state is translucent and strongly light-scattering.
Guest-Host functional elements: The active layer contains dichroic dye molecules (guest) dissolved in liquid crystals (host). The liquid crystals are aligned in the electric field, as a result of which the orientation of the dye molecules is influenced, which results in a changed transmission level (tinting level) and a changed colour.

SPD (suspended particle device) functional elements have an active layer containing suspended particles. The absorption of light by the active layer can be varied by applying a voltage on the planar electrodes, which results in a change in orientation of the suspended particles.

Electrochromic functional elements contain an active layer sequence between the planar electrodes (electrochromic layer sequence), which is arranged in the following order: an ion storage layer, an electrolyte layer, and an electrochromic layer. The electrochromic layer is the actual bearer of the electrically controllable optical properties. It is an electrochemically active layer whose degree of light transmittance is dependent upon the degree of ion storage. The ions (for example H⁺−, Li⁺, Na⁺−, or K⁺ ions) are stored in and provided by the ion storage layer. The electrolyte layer separates the electrochromic layer spatially from the ion storage layer and serves to migrate ions. If a DC voltage of suitable polarity is applied to the planar electrodes, ions will migrate from the ion storage layer, through the electrolyte layer, and into the electrochromic layer, whereupon the optical properties (colour, light transmission) of the electrochromic layer are changed depending upon the quantity of ions that have migrated into said layer. If DC voltage of the opposite polarity is applied to the planar electrodes, the ions will migrate from the electrochromic layer, through the electrolyte layer and back into the ion storage layer and the optical properties of the electrochromic layer change in the opposite manner. If no voltage is applied to the planar electrodes, the current state will remain stable. Suitable electrochromic layers contain electrochromic materials, e.g. inorganic oxides (such as tungsten oxide or vanadium oxide), complex compounds (such as Prussian blue), or conductive polymers (such as 3,4-polyethylene dioxythiophene (PEDOT) or polyaniline). The electrolyte layer is typically designed as a film of organic or inorganic, electrically insulating material with a high degree of ion conductivity-for example, based upon lithium phosphorus oxynitride. The ion storage layer is either permanently transparent (pure ion storage) or has electrochromic behaviour opposite that of the electrochromic layer. One example of pure ion storage is that of layers containing a mixed oxide of titanium and cerium; examples of anodically electrochromic ion storage layers are layers containing iridium oxide or nickel oxide.

The voltage source for the functional element is preferably a control unit which is suitable for operating the functional element. The control unit is suitable for applying a voltage between, on the one hand, the first planar electrode and, on the other hand, the second planar electrode or the electrode segments of the second planar electrode (respectively). Depending on the type of functional element, the voltage provided by the control unit can be a direct voltage (e.g., in the case of electrochromic functional elements) or an alternating voltage (e.g., in the case of SPD functional elements or PDLC functional elements or other functional elements based on liquid crystal technology). If the primary voltage source provides a direct voltage (as is common in a vehicle's electrical system, for example), while the functional element is operated with an alternating voltage, the control unit can include inverters. If the primary voltage source provides an alternating voltage while the functional element is operated with a direct voltage, the control unit can comprise rectifiers.

The control unit is provided and suitable for controlling the optical properties of the functional element. The control unit is electrically conductively connected, on the one hand, to the planar electrodes of the functional element and, on the other hand, to a primary voltage source. The control unit contains the electrical and/or electronic components required for applying the required voltage to the planar electrodes as a function of a switching state. The switching state can be predefined by the user (for example by operating a switch, a button or a rotary or sliding controller), can be determined by sensors and/or can be transmitted via a digital interface from the central control device of the vehicle (if the composite pane is a vehicle window pane, usually LIN bus or CAN bus). The switches, buttons, rotary or sliding controllers can be integrated, for example, in the dashboard of the vehicle if the composite pane is a vehicle window pane. However, touch sensors, for example capacitive or resistive sensors, can also be integrated directly into the composite pane. Alternatively, the functional element can also be controlled by contactless methods, for example by recognising gestures, or as a function of the state of pupil or eyelid determined by a camera and suitable evaluation electronics. The control unit can comprise, for example, electronic processors, voltage converters, transistors and other components.

The control unit may be attached to the interior surface of the inner pane facing away from the intermediate layer or, for example, be integrated into the vehicle's electrical system or be attached to the vehicle body if the composite pane is a vehicle window pane.

The composite pane is typically provided for separating an interior space from the external environment in a window opening (for example a window opening of a vehicle, a building, or a room). In the context of the invention, the term “inner pane” is understood to mean the pane facing the interior space. Outer pane means the pane facing the external environment. The outer pane and the inner pane each have an outer and an interior-side surface and a circumferential side edge surface extending between them. Within the meaning of the invention, the outer surface means the main surface which is intended to face the external environment when installed. Within the meaning of the invention, the interior-side surface means the main surface which is intended to face the interior when installed. The interior-side surface of the outer pane and the outer-side surface of the inner pane face one another and are joined to one another by the thermoplastic intermediate layer.

The outer pane and the inner pane are preferably made or formed of glass, particularly preferably of soda lime glass, as is customary for window panes. However, the panes can also be manufactured from other types of glass, for example quartz glass, borosilicate glass or aluminosilicate glass, or from rigid clear plastics, for example polycarbonate or polymethyl methacrylate. The panes can be clear or also tinted or coloured.

The thickness of the outer pane and of the inner pane can vary widely and accordingly be adapted to the requirements in the individual case. The outer pane and the inner pane preferably have thicknesses of 0.5 mm to 5 mm, particularly preferably of 1 mm to 3 mm. The outer pane and the inner pane can be flat or cylindrical or spherically curved. Spherically curved composite panes are particularly common for vehicle glazing, while flat composite panes are common for building glazing.

The outer pane, the inner pane and/or the intermediate layer can have suitable coatings known per se, for example anti-reflective coatings, non-stick coatings, anti-scratch coatings, photocatalytic coatings, UV-absorbing or reflective coatings or IR-absorbing or reflecting coatings such as sun protection coatings or low-E coatings.

The composite pane can be equipped with an opaque cover printing, in particular at least in a circumferential edge area, as is common practice in the vehicle sector, in particular for windshields, rear windows and roof panes. The cover printing is typically made of an enamel containing glass frits and a pigment, in particular black pigment. The printing ink is typically applied in a screen printing method and is then burned in. Such a cover printing is applied to at least one of the pane surfaces, preferably the interior-side surface of the outer pane and/or inner pane. The cover printing preferably surrounds a central see-through area in a frame-like manner. The cover printing creates an opaque masking area on the composite pane. The contacting areas and the connection area of the functional element are preferably arranged in this masking area.

The thermoplastic intermediate layer serves to connect the two panes, as is common practice with composite panes. Thermoplastic films are typically used, and the intermediate layer is formed therefrom. In a preferred embodiment, the functional element is arranged between two thermoplastic layers. The intermediate layer is formed here at least from a first thermoplastic layer and a second thermoplastic layer, between which the functional element is arranged.

The functional element is then connected to the outer pane via a region of the first thermoplastic layer and to the inner pane via a region of the second thermoplastic layer. The thermoplastic layers preferably project circumferentially beyond the functional element. Where the thermoplastic layers have direct contact with one another and are not separated from one another by the functional element, they can merge together during lamination in such a way that the original layers may no longer be discernible and instead a homogeneous intermediate layer is present.

A thermoplastic layer can be formed, for example, by a single thermoplastic film. A thermoplastic layer can also be formed from sections of different thermoplastic films, the side edges of which are attached to each other.

In a preferred embodiment, the functional element, more precisely the lateral edges of the functional element, is surrounded circumferentially by a third thermoplastic layer. The third thermoplastic layer is frame-like with a recess into which the functional element is inserted. The third thermoplastic layer can be formed by a thermoplastic film into which the recess has been introduced by cutting. Alternatively, the third thermoplastic layer can also be composed of a plurality of film sections around the functional element. The intermediate layer is then formed from a total of at least three thermoplastic layers arranged flat on top of each other, wherein the middle layer has a recess in which the functional element is arranged. During production, the third thermoplastic layer is arranged between the first and the second thermoplastic layer, wherein the lateral edges of all the thermoplastic layers are preferably congruent. The third thermoplastic layer preferably has about the same thickness as the functional element. This compensates for the local thickness difference which is introduced by the locally limited functional element, so that glass breakage during lamination can be avoided and an improved visual appearance result.

Alternatively, however, the functional element can also be arranged directly on the surface of the outer pane or the inner pane facing the intermediate layer. Preferably, the lateral edge of the functional element is completely surrounded by the intermediate layer, so that the functional element does not extend all the way to the lateral edge of the composite pane and therefore has no contact with the surrounding atmosphere. Here, too, the use of a frame-like thermoplastic layer around the functional element is possible.

The thermoplastic layers of the intermediate layer are preferably formed from the same material, but can in principle also be formed from different materials. The layers or films of the intermediate layer are preferably formed based on polyvinyl butyral (PVB), ethylene vinyl acetate (EVA), or polyurethane (PU). This means that the layer or film predominantly contains said material (more than 50% by weight) and can, in addition, optionally contain further constituents, for example plasticisers, stabilisers, UV or IR absorbers. The thickness of each thermoplastic layer is preferably from 0.2 mm to 2 mm, particularly preferably from 0.3 mm to 1 mm. For example, films with standard thicknesses of 0.38 mm or 0.76 mm can be used.

The composite pane can be produced by stacking the individual layers in the intended order to form a stack of layers and then laminating the outer pane and the inner pane together via the intermediate layer. Methods that are known per se can be used, for example autoclave methods, vacuum bag methods, vacuum ring methods, calendering methods, vacuum laminators, or combinations thereof. The outer pane and inner pane are usually connected under the effect of heat, vacuum and/or pressure.

The layer stack preferably comprises, in the specified order:
the outer pane
a first thermoplastic film forming a first thermoplastic layer of the intermediate layer,
the functional element, preferably enclosed in a frame-like third thermoplastic film with a recess,
a second thermoplastic film forming a second thermoplastic layer of the intermediate layer,
the inner pane.

When stacking the layers, the functional element is provided with the required electrical connections, with electrical conductors extending beyond the side edge of the layer stack, to which the external voltage source can later be provided.

In an advantageous embodiment, the functional element is provided with the current collector rails, which are connected to the planar electrodes, optionally via an electrical contact layer. The electrical conductors are provided on the thermoplastic films and positioned appropriately so that when the layer stack is created, the electrical conductors come into contact with the current collector rails without any further measures. The electrical conductors preferably comprise a ribbon conductor arranged laterally of the functional element, an electrical contact element for direct connection to the current collector rails and electrical lines (in particular wires or cables) between each contact element and a conductor track of the ribbon conductor. The electrical conductors are each attached to the thermoplastic film, to which the planar electrode, which is to be contacted with the conductors, is exposed. If, for example, the first carrier film with the first planar electrode faces the first thermoplastic film, the first planar electrode is exposed to the second thermoplastic film in the first contact area: in the first contact area, only the first carrier film and the first planar electrode are present, wherein the first planar electrode faces the second thermoplastic layer.

The invention also comprises the use of a composite pane according to the invention in buildings or in means of transport for land, air or water traffic, for example as a window pane of a vehicle, as a window pane of a building or a room (building interior) or as a component of furniture, electrical appliances or furnishings. The composite pane is preferably the window pane of a vehicle, in particular a motor vehicle. The glazing unit can be used, for example, as a windshield, roof pane, rear wall pane or side pane, preferably as a windshield or roof pane.

In a particularly preferred embodiment, the composite pane is a windshield of a vehicle. The functional element is preferably used then as an electrically controllable sun screen, which is arranged in an upper region of the windshield, while the majority of the windshield is not provided with the functional element. A plurality of switching regions can be provided, which are preferably arranged substantially parallel to the upper edge of the windshield with increasing distance therefrom. As a result of the independently switchable switching regions, the user can determine the extent of the region adjoining the upper edge which is to be shaded or provided with high light scattering, depending on the position of the sun, in order to avoid sun dazzle.

In yet another preferred embodiment, the composite pane is a roof pane of a vehicle. The functional element is then preferably arranged in the entire see-through area of the composite pane. In a typical embodiment, this see-through area comprises the entire composite pane minus a circumferential edge region which is provided with an opaque cover printing on at least one of the surfaces of the panes. The functional element extends over the entire see-through area, wherein its side edges are arranged in the region of the opaque cover printing and are thus not visible to the observer. The switching regions are preferably arranged substantially parallel to the front edge of the roof pane with increasing distance therefrom. By means of the independently switchable switching regions, the user can define which region of the roof pane is to be transparent and which should be shaded or provided with high light scattering, for example as a function of the position of the sun in order to avoid excessive heating of the vehicle interior. It is also possible for each vehicle passenger, i.e. for example, the driver, the front-seat passenger, the passenger in the left-hand back seat and the passenger in the right-hand back seat, to be assigned a switching region located above them.

The invention is explained in more detail with reference to a drawing and exemplary embodiments. The drawing is a schematic representation and is not true to scale. The drawing does not limit the invention in any way. In the drawings:

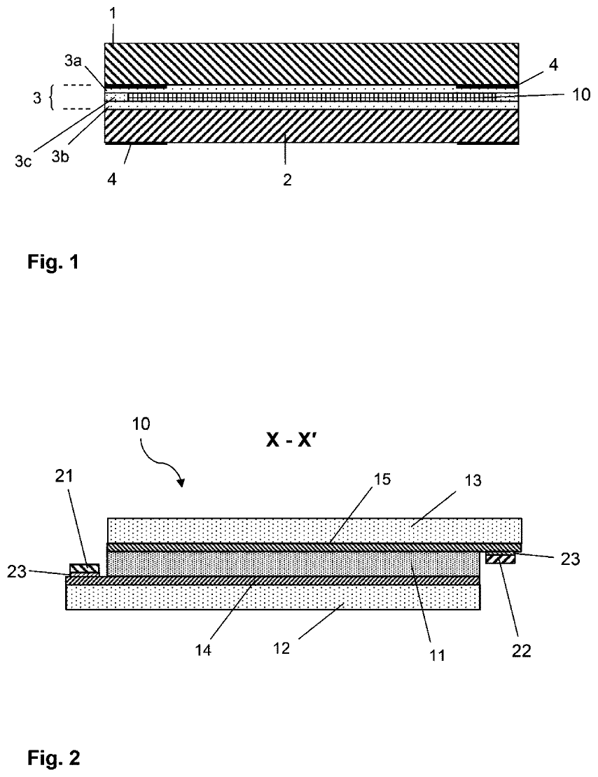

FIG. 1 is a cross section of an embodiment of the composite pane according to the invention,

FIG. 2 is a cross section through the functional element of the composite pane from FIG. 1,

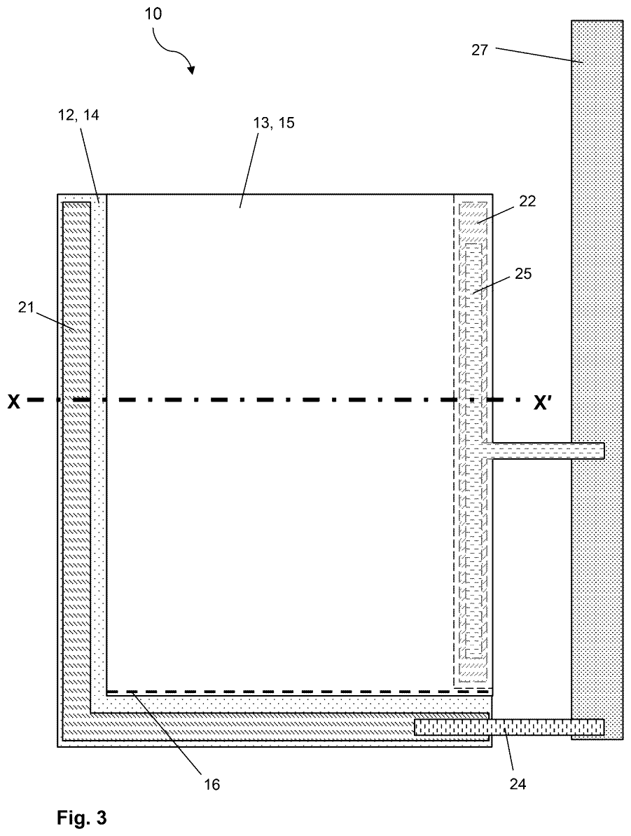

FIG. 3 is a plan view of the functional element from FIG. 2,

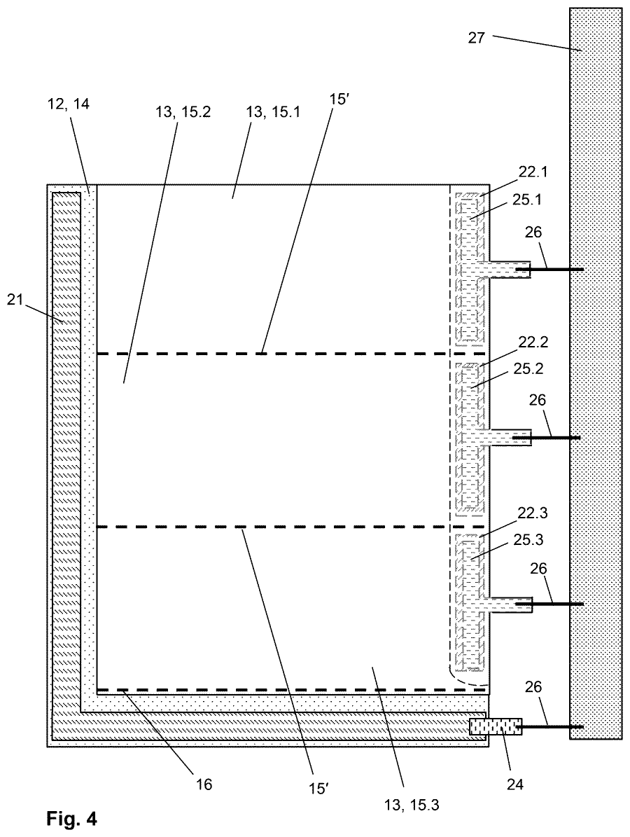

FIG. 4 is a plan view of the functional element of a further embodiment of the composite pane according to the invention,

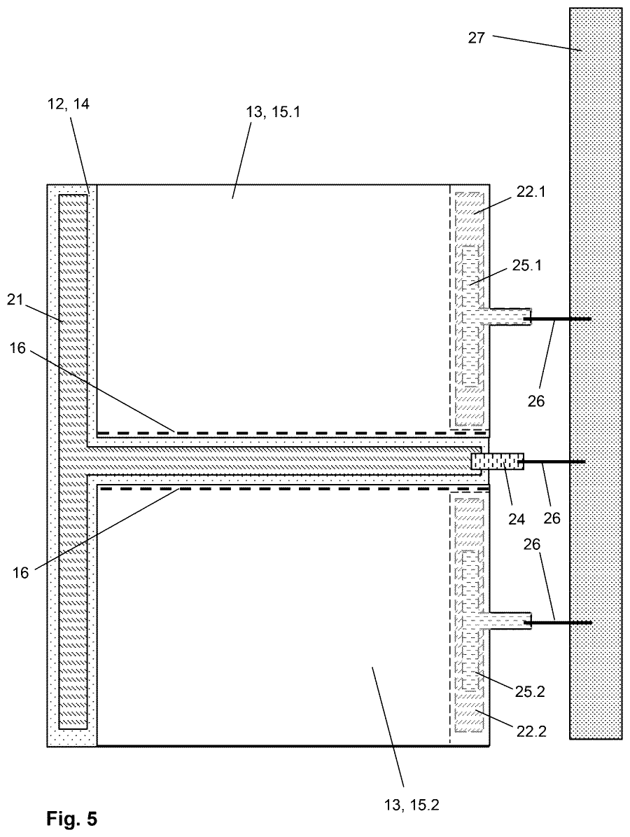

FIG. 5 is a plan view of the functional element of a further embodiment of the composite pane according to the invention, and

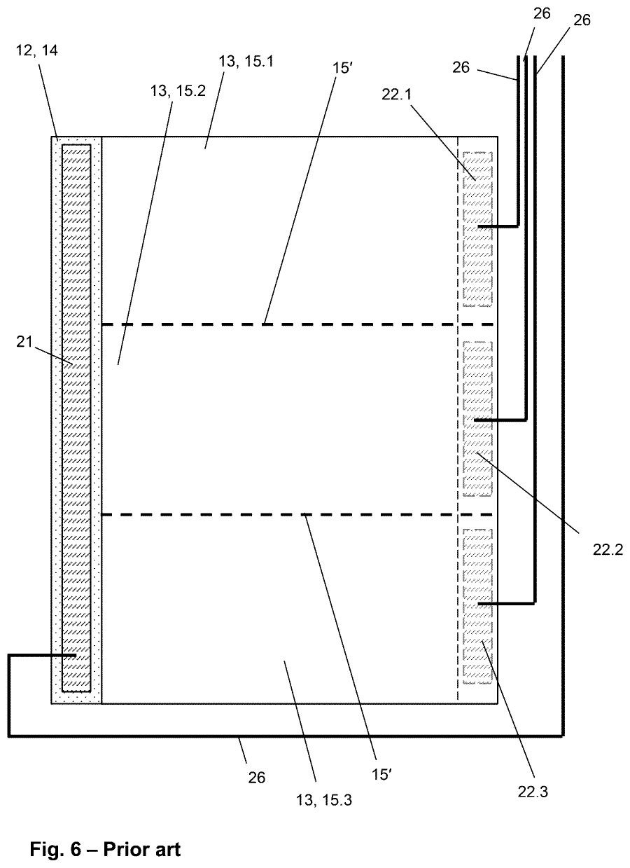

FIG. 6 is a plan view of the functional element of a conventional generic composite pane.

FIG. 1 shows a cross-section of the design of the composite pane according to the invention with electrically controllable optical properties. The composite pane is provided, for example, as a roof pane of a passenger vehicle, the light transmission of which can be electrically controlled. The composite pane comprises an outer pane 1 and an inner pane 2, which are connected to one another via an intermediate layer 3. The outer pane 1 and the inner pane 2 consist of soda lime glass, which can optionally be tinted. The outer pane 1 has, for example, a thickness of 2.1 mm, the inner pane 2 has a thickness of 1.6 mm.

The intermediate layer 3 comprises a total of three thermoplastic layers 3a, 3b, 3c which are each formed by a PVB thermoplastic film having a thickness of 0.38 mm. The first thermoplastic layer 3a is connected to the outer pane 1, the second thermoplastic layer 3b is connected to the inner pane 2. The third thermoplastic layer 3c located in between has a cutout in which a functional element 10 with electrically controllable optical properties is inserted essentially in a precise fit, i.e. approximately flush on all sides. The third thermoplastic layer 3c thus forms as it were a kind of mount or frame for the approximately 0.4 mm thick functional element 10, which is thus encapsulated by the thermoplastic material and protected thereby.

The composite pane has a circumferential edge area that is provided with an opaque cover printing 4. Such cover printing 4 is typically formed from a black enamel. It is imprinted as printing ink with a black pigment and glass frits in a screen printing method and is burned into the pane surface. The cover printing 4 is applied, for example, on the interior-side surface of the outer pane 1 and also on the interior-side surface of the inner pane 2. The side edges of the functional element 10 are covered by this cover printing 4.

For the sake of clarity, FIG. 2 shows a cross section through the functional element 10 from FIG. 1 alone. The functional element 10 is, for example, a PDLC multilayer film which can be switched from a clear, transparent state to an opaque, non-transparent (diffuse) state. The functional element 10 consists of an active layer 11 between a first planar electrode 14 and a second planar electrode 15. The first planar electrode 14 is applied to a first carrier film 12, the second planar electrode 15 to a second carrier film 13. The active layer 11 contains a polymer matrix with liquid crystals dispersed therein, which align depending on the electrical voltage applied to the planar electrodes 14, 15, whereby the optical properties can be controlled. The carrier films 12, 13 are made of PET and have a thickness of, for example, 0.125 mm. The carrier films 12, 13 are each provided with a coating of ITO facing the active layer 11 and having a thickness of approx. 100 nm, said coating forming the planar electrodes 14, 15.

The functional element 10 has a first contacting area in which the first planar electrode 14 is exposed in order to connect it to the voltage source. In the first contacting area, the second carrier film 13, the second planar electrode 15 and the active layer 11 are removed. In the first contacting area, a current collector rail 21 is arranged on the first planar electrode 14 via an electrical contact layer 23.

The functional element 10 has a second contacting area in which the second planar electrode 15 is exposed in order to connect it to the voltage source. In the second contacting area, the first carrier film 12, the first planar electrode 14 and the active layer 11 are removed. In the second contacting area, a current collector rail 22 is arranged on the second planar electrode 15 via an electrical contact layer 23.

FIG. 3 shows a plan view of the functional element 10 from FIG. 2. The second carrier film 13 is facing the viewer. The functional element has a rectangular shape with four straight side portions and four corners.

The first contacting area extends along the left side portion and directly adjoins the side edge of the functional element 10. There, the second carrier film 13 with the second planar electrode 15 and the active layer 11 are removed, so that the exposed first planar electrode 14 on the first carrier layer 12 can be seen (shown in dotted lines).

The second contacting area extends along the right side portion and directly adjoins the side edge of the functional element 10. There, the first carrier film 12 with the first planar electrode 14 and the active layer 11 are removed. The second planar electrode 15 is not visible here because it is covered by the second carrier film 13 on top. The left boundary of the second contacting area (cutting line) is indicated by a thin dashed line.

The current collector rail 22 is arranged on the second planar electrode 15 in the second contacting area. It is shown with a dashed outline and in grey because it is located behind the second carrier film 13 and is therefore only visible when viewed through it. In the first contacting area, the current collector rail 21 is arranged on the first planar electrode 14.

Adjacent to the lower side edge, a connection area runs from the first contacting area to the opposite right side portion of the functional element 10. In the connection area, just like in the first contacting area, the second carrier film 13, the second planar electrode 15 and the active layer 11 are removed, such that the first planar electrode 14 is exposed.

A portion of the current collector rail 21 of the first planar electrode 14 is arranged in the first contacting area. A further portion is arranged in the connection area starting from the first contacting area to the opposite right side portion of the functional element 10. This has the advantage that both current collector rails 21, 22 can be electrically connected to the same side of the functional element 10, namely the right side portion.

The dashed outline of the second contacting area corresponds to the cutting line for removing the first carrier film 12. In the plan view shown, it is located below the second contacting area to the side edge of the functional element in the right side portion before it reaches the connection area. As a result, an intermediate area is arranged between the second contacting area and the connection area, in which the first carrier film 12, the first planar electrode 14 and the active layer 11 are not removed.

For electrical connection to the external voltage source, the composite pane is equipped with a ribbon conductor 27, which is arranged laterally of the functional element 10, spaced from the right side portion. The ribbon conductor 27 extends beyond the side edge of the composite pane. A T-shaped electrical contact element 25 is arranged on the current collector rail 22 of the second planar electrode 15 and is directly connected to the ribbon conductor 27. The majority of the contact element 25 is again shown with a dashed outline and in grey because it is located behind the second carrier film 13 and the current collector rail 22. On the current collector rail 21 of the first planar electrode 14, a strip-like electrical contact element 24 is arranged in the connection area and is directly connected to the ribbon conductor 27. Each contact element 24, 25 is connected to one of two conductor tracks of the ribbon conductor 27, which is not shown for the sake of simplicity.

The current collector rails have, for example, a width of 5 mm. They are made of a copper foil with a thickness of, for example, 50 μm. The electrical contact layers 23 consist, for example, of a silver paste with a thickness of 50 μm. The electrical contact elements 24, 25 are also formed, for example, from a copper foil with a thickness of, for example, 50 μm.

In the intermediate area between the second contacting area and the connection area, a part of the second planar electrode 15 is electrically insulated from the remaining second planar electrode 15 by an insulation line 16. The insulation line 16 divides the second planar electrode 15 into an active area, which acts as the actual planar electrode, and an area insulated therefrom, which adjoins the connection area. This reduces the risk of a short circuit, since the part of the second planar electrode 15 adjacent to the connection area can easily come into contact with the first planar electrode 14 or its current collector rail 21. The insulation line 16 is introduced into the second planar electrode 15 by laser radiation and has a line width of, for example, 100 μm.

FIG. 4 shows a plan view of the functional element 10 in a further embodiment of the composite pane according to the invention. The functional element 10 is basically constructed in the same way as in the embodiment shown in FIGS. 2 and 3. In contrast, the functional element 10 has three independent switching regions in which the switching state can be set independently of one another. With the switching regions, the driver of the vehicle can choose (for example as a function of the position of the sun) to provide only one region of the composite pane instead of the entire composite pane with the diffuse state, while the other regions remain transparent.

For this purpose, the second planar electrode 15 is divided into three electrode segments 15.1, 15.2, 15.3 by two insulation lines 15′. The insulation lines 15′ are introduced into the planar electrode 15 by laser radiation and have a line width of, for example, 100 μm. Each electrode segment 15.1, 15.2, 15.3 is connected to the voltage source independently of the others. A control unit is suitable for applying, independently of one another, an electrical voltage between each electrode segment 15.1, 15.2, 15.3 of the first planar electrode 15, on the one hand, and the first planar electrode 14, on the other hand, so that the portion of the active layer 11 located in between is subjected to the required voltage in order to achieve a desired switching state.

Each electrode segment 15.1, 15.2, 15.3 is provided in the second contact area with a current collector rail 22.1, 22.2, 22.3, which in turn is provided with an electrical contact element 25.1, 25.2, 25.3. In contrast to the design of FIGS. 2 and 3, the contact elements 24, 25.1, 25.2, 25.3 are not connected directly to the ribbon conductor 27, but rather via an electrical line 26 connected thereto. The ribbon conductor 27 has at least four conductor tracks, wherein each current collector rail 21, 22.1, 22.2, 22.3 is connected to a separate conductor track. The electrical lines 26 are formed, for example, as tungsten wires with a diameter of 150 μm.

A further difference to the design of FIGS. 2 and 3 is the shape of the dashed outline of the second contacting area. This does not form a right angle below the second contacting area in order to be guided to the right side portion. Instead, it describes a curve, which is technically easier to implement.

In this embodiment, too, in the intermediate area between the second contacting area and the connection area, a part of the second planar electrode 15 is electrically insulated from the remaining second planar electrode 15 by an insulation line 16. The insulation line 16 divides the second planar electrode 15 into an active area, which acts as the actual planar electrode and is divided into three independent segments 15.1, 15.2, 15.3, and an area insulated therefrom, which adjoins the connection area. This reduces the risk of a short circuit, since the part of the second planar electrode 15 adjacent to the connection area can easily come into contact with the first planar electrode 14 or its current collector rail 21. The insulation line 16 is introduced into the second planar electrode 15 by laser radiation and has a line width of, for example, 100 μm. Since the functional element 10 is already subjected to a laser process to produce the insulation lines 15′, the production of the insulation line 16 only requires a small additional outlay.

FIG. 5 shows a plan view of the functional element 10 in a further embodiment of the composite pane according to the invention. The functional element 10 is basically constructed in the same way as in the embodiment shown in FIGS. 2 and 3. In contrast, the connection area is not arranged adjacently to the lower side portion, but in a central region of the functional element 10.

Since the second carrier film 13 with the second planar electrode 15 and the active layer 11 are removed in the connection area, the functional element is divided by the connection area into two switching regions in which the optical properties can be electrically controlled. In the switching regions, the carrier films 12, 13, the planar electrodes 14, 15 and the active layer 11 are completely present. The second planar electrode 15 is divided into two electrode segments 15.1, 15.2 by the connection area. The second contact area is also divided into two portions. Each electrode segment 15.1, 15.2 is provided in the second contact area with a current collector rail 22.1, 22.2, which in turn is connected to the ribbon conductor 27 via an electrical contact element 25.1, 25.2 and an electrical line 26 connected thereto. The ribbon conductor 27 has at least three conductor tracks, wherein each current collector rail 21, 22.1, 22.2 is connected to a separate conductor track.

Between each portion of the second contact area and the connection area, an intermediate area is again arranged in the illustrated plan view, in which the first carrier film 12, the first planar electrode 14 and the active layer 11 are not removed. In each intermediate area, an insulation line 16 is arranged, which divides the respective portion of the second planar electrode 15 into an active portion and a portion insulated therefrom, adjacent to the connection area, which serves to avoid short circuits in the connection area.

For comparison, FIG. 6 shows a plan view of the functional element 10 in a conventional design of a generic composite pane. As in FIG. 4, the functional element 10 is divided into three independent switching regions.

The electrical connection is made via electrical lines 26, which extend from the respective current collector rail beyond the side edge of the composite pane. The connection of the current collector rail 21 of the first planar electrode 14 is made on the left side of the functional element 10, the connection of the current collector rails 22.1, 22.2, 22.3 on the right side of the functional element 10. However, since the lines 26 are intended to leave the composite pane at approximately the same point, since they are typically combined with a common connector to connect them to the voltage source, the line 26 of the current collector rail 21 is routed around the functional element 10. Therefore, longer cables 26 are required than in the embodiment according to the invention, and their installation requires more time.

### List of Reference Signs

(1) Outer pane
(2) Inner pane
(3) Thermoplastic intermediate layer
(3a) First layer of the intermediate layer 3
(3b) Second layer of the intermediate layer 3
(3c) Third layer of the intermediate layer 3
(4) Cover printing
(10) Electrically controllable functional element
(11) Active layer of the functional element 4 layer sequence with electrically controllable optical properties
(12) First carrier film of the functional element 4
(13) Second carrier film of the functional element 4
(14) First planar electrode of the functional element 4
(15) Second planar electrode of the functional element 4
(15.1, 15.2, 15.3) Electrode segments of the second planar electrode 15
(15′) Insulation line between two electrode segments 15.1, 15.2, 15.3
(16) Insulation line
(21) Current collector rail of the first planar electrode 14
(22) Current collector rail of the second planar electrode 15
(22.1, 22.2, 22.3) First, second, third current collector rail of the second planar electrode 15
(23) Electrical contact layer
(24) Electrical contact element of the current collector rail 21
(25) Electrical contact element of the current collector rail 22
(25.1, 25.2, 25.3) Electrical contact element of the first, second, third current collector rail of the second planar electrode 15
(26) Electrical line
(27) Ribbon conductor
X-X′ Cutting line

1. A composite pane having electrically controllable optical properties, comprising:
an outer pane and an inner pane which are connected to one another via a thermoplastic intermediate layer,
an electrically controllable functional element embedded in the intermediate layer, which comprises, in the specified order
a first carrier film,
a first planar electrode
an active layer or layer sequence with electrically controllable optical properties,
a second planar electrode and
a second carrier film,
wherein
the second carrier film, the second planar electrode and the active layer or layer sequence are removed and the first planar electrode is electrically conductively connected to a current collector rail in a first contacting area, and
the first carrier film, the first planar electrode and the active layer or layer sequence are removed and the second planar electrode is electrically conductively connected to at least one current collector rail in a second contacting area,
wherein the first contacting area and the second contacting area are arranged on opposite sides of the functional element,
wherein the current collector rail of the first planar electrode extends in a connection area from the first contacting area to the opposite side of the functional element, wherein the second carrier film, the second planar electrode and the active layer or layer sequence are removed in the connection area,
wherein between the second contacting area and the connection area there is an intermediate area in which the first carrier film, the first planar electrode and the active layer or layer sequence are not removed, and wherein in the intermediate area a part of the second planar electrode which adjoins the connection area is electrically insulated from the remaining second planar electrode by an insulation line.

2. The composite pane according to claim 1, wherein the current collector rail of the first planar electrode and the at least one current collector rail of the second planar electrode are connected to a voltage source via electrical conductors and wherein the electrical conductors are connected on the same side of the functional element to the current collector rail of the first planar electrode and the at least one current collector rail of the second planar electrode.

3. The composite pane according to claim 1, wherein the second planar electrode is divided by at least one insulation line into at least two separate electrode segments and wherein each electrode segment is electrically conductively connected to a respective current collector rail.

4. The composite pane according to claim 1, wherein the insulation line or each insulation line has a width of 5 μm to 500 μm.

5. The composite pane according to claim 1, wherein the functional element has an at least approximately quadrangular, in particular at least approximately rectangular, shape.

6. The composite pane according to claim 1, wherein the functional element is a functional element based on liquid crystal technology.

7. The composite pane according to claim 1, wherein the current collector rails are formed from an electrically conductive foil.

8. The composite pane according to claim 1, wherein the planar electrodes are formed on the basis of indium tin oxide (ITO) or silver.

9. The composite pane according to claim 1, which has a ribbon conductor which is arranged laterally of the functional element and extends beyond the side edge of the composite pane, wherein the current collector rail of the first planar electrode and the at least one current collector rail of the second planar electrode are electrically conductively connected to the ribbon conductor.

10. The composite pane according to claim 9, wherein the current collector rails are each provided with an electrical contact element which is formed from an electrically conductive foil and is connected to the ribbon conductor directly or via a respective electrical line wherein the electrical lines are formed as metal wires, electrical cables or printed lines.

11. The composite pane according to claim 1, wherein the carrier films are formed on the basis of polyethylene terephthalate (PET).

12. The composite pane according to claim 1, wherein the functional element is arranged between two thermoplastic layers.

13. The composite pane according to claim 1, wherein the outer pane and the inner pane are made of soda-lime glass.

14. A method comprising providing a composite pane according to claim 1 as a window pane of a vehicle, as a window pane of a building or an interior space or as a component of furniture, electrical appliances or furnishings.

15. The composite pane according to claim 6, wherein the functional element is a PDLC functional element, an SPD functional element or an electrochromic functional element.

16. The composite pane according to claim 7, wherein the electrically conductive foil is a copper foil.

17. The composite pane according to claim 10, wherein the electrically conductive foil is a copper foil.

18. The composite pane according to claim 11, wherein the carrier films have a thickness of 10 μm to 200 μm.

19. The composite pane according to claim 12, wherein the two thermoplastic layers are based on polyvinyl butyral (PVB), ethylene-vinyl acetate (EVA) or polyurethane (PU).

20. The composite pane according to claim 12, wherein the two thermoplastic layers have a thickness of 0.2 mm to 2 mm.
